(19) United States
(12) Patent Application Publication
(10) Pub. No.: US 2017/0315543 A1
(43) Pub. Date: Nov. 2, 2017

(54) EVALUATING PETROCHEMICAL PLANT ERRORS TO DETERMINE EQUIPMENT CHANGES FOR OPTIMIZED OPERATIONS

(71) Applicant: UOP LLC, Des Plaines, IL (US)

(72) Inventors: Ian G. Horn, Streamwood, IL (US); Christophe Romatier, Wilmette, IL (US); Paul Kowalczyk, Hoffman Estates, IL (US); Zak Alzein, Burr Ridge, IL (US)

(21) Appl. No.: 15/640,120

(22) Filed: Jun. 30, 2017

Related U.S. Application Data
(63) Continuation-in-part of application No. 15/084,291, filed on Mar. 29, 2016.
(60) Provisional application No. 62/140,039, filed on Mar. 30, 2015.

(51) Int. Cl. G05B 19/418

(52) U.S. Cl. CPC G05B 19/41885; G05B 2219/32128; G05B 2219/37371

(57) ABSTRACT

A chemical plant or refinery may include process equipment, such as, for example, pumps, compressors, heat exchangers, fired heaters, control valves, fractionation columns, and reactors. Performance monitoring equipment may monitor the process equipment for one or more factors, such as temperature, pressure, feed flow, product flow, density, and specific composition. Monitoring to detect and diagnose operational errors or inefficiencies may allow for optimizing product output from a refinery or petrochemical facility.

### CROSS-REFERENCE TO RELATED APPLICATIONS

This application is a continuation-in-part of U.S. application Ser. No. 15/084,291, filed Mar. 29, 2016, which claims priority under 35 U.S.C. §119(e) of U.S. Provisional Application Ser. No. 62/140,039, filed Mar. 30, 2015, each of which is incorporated herein by reference in its entirety.

### FIELD

The present disclosure is related to a chemical plant or refinery. Specifically, the disclosure is related to early fault diagnosis of plant optimization opportunities to minimize impact on operations.

### BACKGROUND

Companies operating refineries and petrochemical plants typically face tough challenges in today's environment. These challenges may include increasingly complex technologies, a reduction in workforce experience levels, and/or constantly changing environmental regulations.

Furthermore, as feed and product demand become more volatile, operators often find it more difficult to make the operating decisions that may optimize their operations. This volatility may be unlikely to ease in the foreseeable future; but it may represent potential to those companies that may quickly identify and respond to opportunities as they arise.

Pressures generally force operating companies to continually increase the return on existing assets. In response, catalyst, adsorbent, equipment, and/or control system suppliers develop more complex systems that may increase asset performance. Maintenance and operations of these advanced systems generally requires increased skill levels that may be difficult to develop, maintain, and transfer, given the time pressures and limited resources of today's technical personnel. This means that these increasingly complex systems are not always operated to their highest potential. In addition, when existing assets are operated close to and beyond their design limits, reliability concerns and operational risks may increase.

Plant operators typically respond to above challenges with one or more of several strategies, such as, for example, availability risk reduction, working the value chain, and continuous optimization. Availability risk reduction generally places an emphasis on achieving adequate plant operations as opposed to maximizing performance. Working the value chain typically places an emphasis on improving the match of feed and product mix with asset capabilities and market demands. Continuous optimization often employs tools, systems and models to continuously monitor and bridge the gaps in plant performance.

In a typical data cleansing process, only flow meters are corrected. Data cleansing is performed to correct flow meter calibration and fluid density changes, after which the total error of flow meters in a mass balance envelope is averaged to force a 100% mass balance between the net feed and net product flows. But this conventional data cleansing practice ignores other related process information available (e.g., temperatures, pressures, and internal flows) and does not allow for an early detection of a significant error. Specifically, the errors associated with the flow meters are distributed among the flow meters, and thus it is difficult to detect an error of a specific flow meter. Therefore, there is a need for improved data cleansing for chemical plants and refineries.

### SUMMARY

A general object of the disclosure is to improve operation efficiency of chemical plants and refineries. A more specific object of this disclosure is to overcome one or more of the problems described above. A general object of this disclosure may be attained, at least in part, through a method for improving operation of a plant.

A method for improving operation of a plant may include obtaining plant operation information from the plant and generating a plant process model using the plant operation information. The plant operation information may, in some embodiments, include one or more factors, such as a temperature, a pressure, a feed flow, a product flow, and the like. In some embodiments, the plant operation information may include, for example, a density, a specific composition, and the like.

Some embodiments may use process measurements from, for example, pressure sensors, differential pressure sensors, orifice plates, venturi, other flow sensors, temperature sensors, capacitance sensors, weight sensors, gas chromatographs, moisture sensors, and other sensors commonly found in the refining and petrochemical industry. Alternatively or additionally, some embodiments may use process laboratory measurements from gas chromatographs, liquid chromatographs, distillation measurements, octane measurements, and other laboratory measurements commonly found in the refining and petrochemical industry.

The process measurements may be used to monitor the performance of process equipment, such as, for example, pumps, compressors, heat exchangers, fired heaters, control valves, fractionation columns, reactors, and/or other process equipment commonly found in the refining and petrochemical industry.

Some embodiments may use configured process models to reconcile measurements within individual process units, operating blocks, and/or complete processing systems. Routine and frequent analysis of model predicted values versus actual measured values may allow early identification of measurement errors that may be acted upon to minimize impact on operations.

Some embodiments may be implemented using a web-based computer system. The benefits of executing work processes within this platform may include improved plant performance due to an increased ability by operations to identify and capture opportunities, a sustained ability to bridge performance gaps, an increased ability to leverage personnel expertise, and improved enterprise tuning. Advanced computing technology in combination with other parameters may change the way plants, such as refineries and petrochemical facilities, are operated.

A data collection system at a plant may capture data that is automatically sent to a remote location, where it may be reviewed to, for example, eliminate errors and biases, and used to calculate and report performance results. The performance of the plant and/or individual process units of the plant may be compared to the performance predicted by one or more process models to identify any operating differences, or gaps.

A report, such as a daily report, showing actual measured values compared to predicted values may be generated and delivered to a plant operator and/or a plant or third party process engineer via a network, such as, for example, the internet. The identified performance gaps may allow the operators and/or engineers to identify and resolve the cause of the gaps. The process models and plant operation information may be used to run optimization routines that converge on an optimal plant operation for the given values of, for example, feed, products and demand.

Thus, plant operators and/or engineers may receive regular advice and/or recommendations to adjust setpoints or reference points allowing the plant to run continuously at or closer to optimal conditions. The operator may thus receive alternatives for improving or modifying the future operations of the plant. In some embodiments, the system may regularly maintains and tunes the process models to correctly represent the true potential performance of the plant. Some embodiments may include optimization routines configured per specific criteria, which may be used to identify optimum operating points, evaluate alternative operations, and/or evaluate feed.

The present disclosure provides a repeatable method that may help refiners bridge the gap between actual and achievable performance. The method of this disclosure may use process development history, modeling and stream characterization, and plant automation experience to address the critical issues of ensuring data security as well as efficient aggregation, tuning and movement of large amounts of data. Web-based optimization may enable achieving and sustaining maximum process performance by connecting, on a virtual basis, technical expertise and the plant process operations staff.

The enhanced workflow may use configured process models to monitor, predict, and optimize performance of individual process units, operating blocks, or complete processing systems. Routine and frequent analysis of predicted versus actual performance allows early identification of operational discrepancies, which may be acted upon to optimize impact.

As used herein, references to a “routine” are to be understood to refer to a sequence of computer programs or instructions for performing a particular task. References herein to a “plant” are to be understood to refer to any of various types of chemical and petrochemical manufacturing or refining facilities. References herein to a plant “operators” are to be understood to refer to and/or include, without limitation, plant planners, managers, engineers, technicians, and others interested in, overseeing, and/or running the daily operations at a plant.

In some embodiments, a cleansing system is provided for improving measurement error estimation and detection. A server is coupled to the cleansing system for communicating with the plant via a communication network. A computer system has a web-based platform for receiving and sending plant data related to the operation of the plant over the network. A display device interactively displays the plant data. A data cleansing unit is configured for performing an enhanced data cleansing process for allowing an early detection and diagnosis of the measurement errors of the plant based on at least one environmental factor. The data cleansing unit calculates and evaluates an offset amount representing a difference between feed or measured and product or simulated information for detecting an error of equipment or measurement during the operation of the plant based on the plant data.

In another embodiment, a cleansing method for improving measurement error detection of a plant is provided, and includes providing a server coupled to a cleansing system for communicating with the plant via a communication network; providing a computer system having a web-based platform for receiving and sending plant data related to the operation of the plant over the network; providing a display device for interactively displaying the plant data, the display device being configured for graphically or textually receiving the plant data; obtaining the plant data from the plant over the network; performing an enhanced data cleansing process for allowing an early detection and diagnosis of the operation of the plant based on at least one environmental factor; and calculating and evaluating an offset amount representing a difference between feed or measured and product or simulated information for detecting an error of equipment or measurement during the operation of the plant based on the plant data.

The foregoing and other aspects and features of the present disclosure will become apparent to those of reasonable skill in the art from the following detailed description, as considered in conjunction with the accompanying drawings.

### BRIEF DESCRIPTION OF THE DRAWINGS

FIG. 1 depicts an illustrative use of the present data cleansing system in a network infrastructure in accordance with one or more embodiments of the present disclosure;

FIG. 2 is a functional block diagram of the present data cleansing system featuring functional units in accordance with one or more embodiments of the present disclosure; and

FIG. 3 depicts an illustrative data cleansing method in accordance with one or more embodiments of the present disclosure.

### DETAILED DESCRIPTION

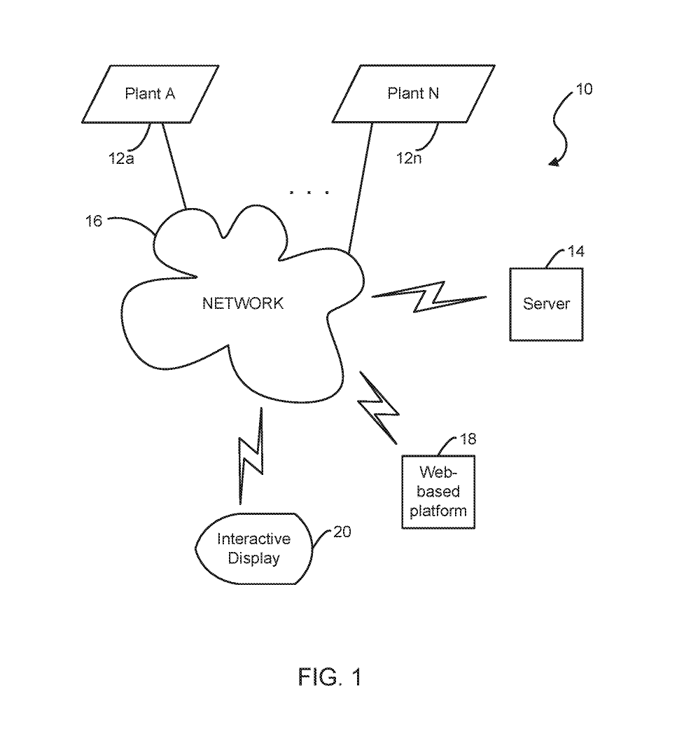

Referring now to FIG. 1, an illustrative data cleansing system, generally designated 10, using an embodiment of the present disclosure is provided for improving operation of one or more plants (e.g., Plant A . . . Plant N) 12a-12n, such as a chemical plant or refinery, or a portion thereof. The present data cleansing system 10 uses plant operation information obtained from at least one of plants 12a-12n.

As used herein, the term “system,” “unit,” or “module” may refer to, be part of, or include an Application Specific Integrated Circuit (ASIC), an electronic circuit, memory (shared, dedicated, or group), and/or a computer processor (shared, dedicated, or group) that executes one or more computer-executable instructions (e.g., software or firmware programs), a combinational logic circuit, and/or other suitable components that provide the described functionality. Thus, while this disclosure includes particular examples and arrangements of the units, the scope of the present system is not so limited, since other modifications will become apparent to the skilled practitioner.

The data cleansing system 10 may reside in or be coupled to a server or computing device 14 (including, e.g., database and video servers), and may be programmed to perform tasks and display relevant data for different functional units via a communication network 16, which may use a secured cloud computing infrastructure. Other suitable networks may be used, such as the internet, a wireless network (e.g., Wi-Fi), a corporate intranet, a local area network (LAN), a wide area network (WAN), and the like, using dial-in connections, cable modems, high-speed integrated services digital network (ISDN) lines, and/or other types of communication methods. Some or all relevant information may be stored in databases for retrieval by the data cleansing system 10 or the computing device 14 (e.g., as a data storage device and/or a machine-readable data storage medium carrying computer programs).

Further, the present data cleansing system 10 may be partially or fully automated. In some embodiments, the data cleansing system 10 is performed by a computer system, such as a third-party computer system, local to or remote from the plants 12a-12n and/or the plant planning center. The present data cleansing system 10 may include a web-based platform 18 that obtains or receives and sends information over a network, such as the internet. Specifically, the data cleansing system 10 may receive signals and/or parameters from at least one of the plants 12a-12n via the communication network 16, and may cause display (e.g., in real time or after a delay) of related performance information on an interactive display device 20 accessible to an operator or user.

Using a web-based system for implementing the method may provide many benefits, such as improved plant performance due to an increased ability by plant operators to identify and capture opportunities, a sustained ability to bridge plant performance gaps, and/or an increased ability to leverage personnel expertise and improve training and development. Some embodiments may allow for automated daily evaluation of process measurements, thereby increasing the frequency of performance review with less time and effort from plant operations staff.

The web-based platform 18 may allow all users to work with the same information, thereby creating a collaborative environment for sharing best practices or for troubleshooting. The method of this disclosure provides more accurate prediction and optimization results due to fully configured models, which may include, for example, catalytic yield representations, constraints, degrees of freedom, and the like. Routine automated evaluation of plant planning and operation models may allow timely plant model tuning to reduce or eliminate gaps between plant models and the actual plant performance. Implementing the method of this disclosure using the web-based platform 18 may allow for monitoring and updating multiple sites, thereby better enabling facility planners to propose realistic optimal targets.

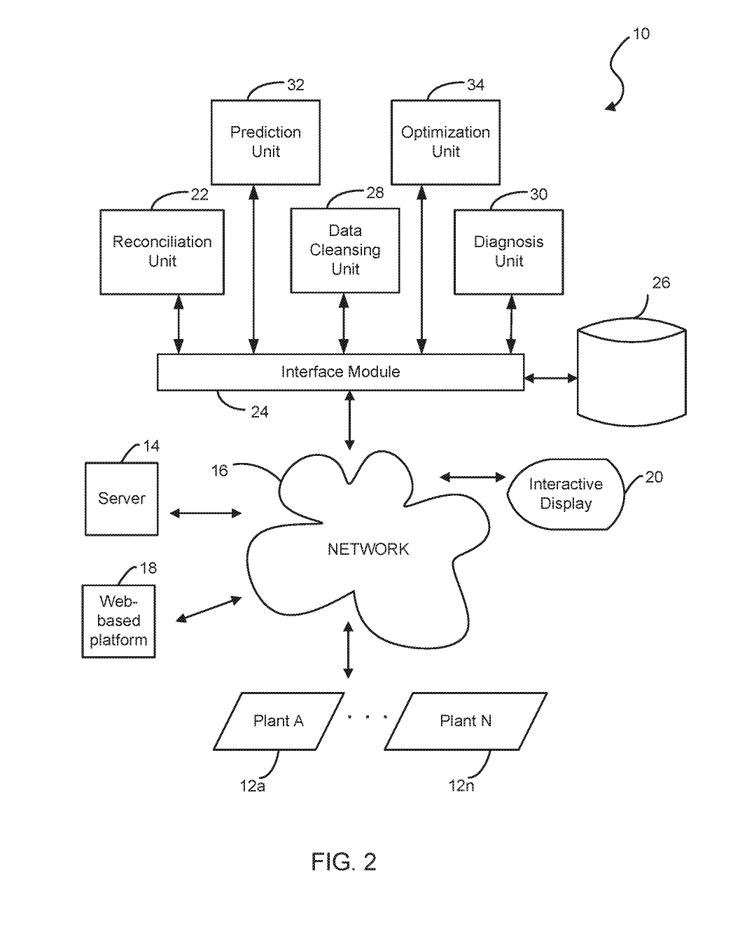

Referring now to FIG. 2, the present data cleansing system 10 may include a reconciliation unit 22 configured for reconciling actual measured data from the respective plants 12a-12n in comparison with process model results from a simulation engine based on a set of reference or set points. In some embodiments, a heuristic analysis may be performed against the actual measured data and the process model results using a set of predetermined threshold values. A statistical analysis and other suitable analytic techniques may be used to suit different applications.

As an example only, kinetic or other associated plant parameters relating to temperatures, pressures, feed compositions, fractionation columns, and the like, may be received from the respective plants 12a-12n. These plant parameters may represent actual measured data from selected pieces of equipment in the plants 12a-12n during a predetermined time period. Comparisons of these plant operational parameters may be performed with the process model results from the simulation engine based on predetermined threshold values.

The data cleansing system 10 may include an interface module 24 for providing an interface between the data cleansing system 10, one or more internal or external databases 26, and/or the network 16. The interface module 24 receives data from, for example, plant sensors and parameters via the network 16, and other related system devices, services, and applications. The other devices, services, and applications may include, but are not limited to, one or more software or hardware components related to the respective plants 12a-12n. The interface module 24 also receives the signals and/or parameters, which are communicated to the respective units and modules, such as the data cleansing system 10 and its associated computing modules or units.

A data cleansing unit 28 may be provided for performing an enhanced data cleansing process for allowing an early detection and diagnosis of plant operation based on one or more environmental factors. As discussed above, the environmental factors may include one or more primary factors and/or one or more secondary factors. The primary factor may include, for example, a temperature, a pressure, a feed flow, a product flow, or the like. The secondary factor may include, for example, a density, a specific composition, or the like. An offset amount representing a difference between the feed and product information may be calculated and/or evaluated for detecting an error of specific equipment during plant operation.

In operation, the data cleansing unit 28 may receive at least one set of actual measured data from a customer site or at least one of plants 12a-12n on a recurring basis at a specified time interval (e.g., every 100 milliseconds, every second, every ten seconds, every minute, every two minutes). For data cleansing, the received data may be analyzed for completeness and corrected for gross errors by the data cleansing unit 28. Then, the data is corrected for measurement issues (e.g., an accuracy problem for establishing a simulation steady state) and overall mass balance closure to generate a duplicate set of reconciled plant data.

By performing data reconciliation over an entire sub-section of the flowsheet, substantially all of the process data relating to particular equipment is used to reconcile the associated operational plant parameters. As described in greater detail below, one or more plant operational parameters, such as a mass flow rate, may be used in the correction of the mass balance. Offsets calculated for the plant measurements may be tracked and stored in the database 26 for subsequent retrieval.

The data cleansing system 10 may include a diagnosis unit 30 configured for diagnosing an operational status of a measurement based on at least one environmental factor. The diagnosis unit 30 may evaluate the calculated offsets between the plant measurements and process simulation based on the at least one environmental factor for detecting a fault or error of specific plant measurement during plant operation. Thus, plant equipment may be evaluated and diagnosed for the fault without distributing measurement errors for the rest of plant equipment.

In some embodiments, the diagnosis unit 30 may receive the feed and product information from at least one of the plants 12a-12n to proactively evaluate a specific piece of plant equipment. To evaluate various limits of a particular process and stay within the acceptable range of limits, the diagnosis unit 30 determines target tolerance levels of a final product based on actual current and/or historical operational parameters, e.g., from a flow rate, a heater, a temperature set point, a pressure signal, and/or the like. When the offsets are different from previously calculated offsets by a predetermined value, the diagnosis unit 30 may determine that the specific measurement is faulty or in error. An additional reliability heuristic analysis may be performed on this diagnosis in certain cases.

In using the kinetic model or other detailed calculations, the diagnosis unit 30 establishes boundaries or thresholds of operating parameters based on existing limits and/or operating conditions. Illustrative existing limits may include mechanical pressures, temperature limits, hydraulic pressure limits, and operating lives of various components. Other suitable limits and conditions may suit different applications.

The data cleansing system 10 may include a prediction unit 32 configured such that the corrected data is used as an input to a simulation process, in which the process model is tuned to ensure that the simulation process matches the reconciled plant data. The prediction unit 32 performs that an output of the reconciled plant data is inputted into a tuned flowsheet, and then is generated as a predicted data. Each flowsheet may be a collection of virtual process model objects as a unit of process design. A delta value, which is a difference between the reconciled data and the predicted data, is validated to ensure that a viable optimization case is established for a simulation process run.

The data cleansing system 10 may include an optimization unit 34 configured such that the tuned simulation engine is used as a basis for the optimization case, which is run with a set of the reconciled data as an input. The output from this step may be a new set of data, namely an optimized data. A difference between the reconciled data and the optimized data may provide an indication as to how the operations may be changed to reach a greater optimum. In this configuration, the data cleansing unit 28 provides a user-configurable method for minimizing objective functions, thereby maximizing production of at least one of the plants 12a-12n.

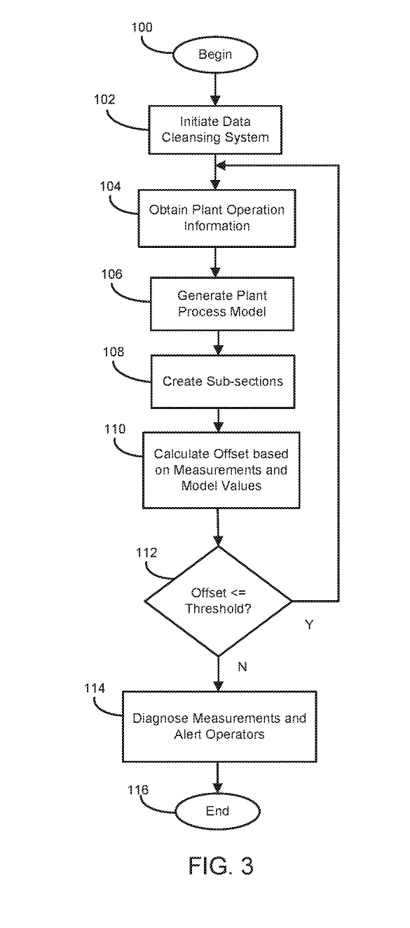

Referring now to FIG. 3, a simplified flow diagram is depicted for an illustrative method of improving operation of a plant, such as one or more of the plants 12a-12n of FIGS. 1 and 2, according to one or more embodiments of this disclosure. Although the following steps are primarily described with respect to the embodiments of FIGS. 1 and 2, the steps within the method may be modified and executed in a different order or sequence without altering the principles of the present disclosure.

The method begins at step 100. In step 102, the data cleansing system 10 is initiated by a computer system that is at or remote from one or more of plants 12a-12n. The method may be automatically performed by the computer system, but the disclosure is not so limited. One or more steps may include manual operations or data inputs from the sensors and other related systems, as desired.

In step 104, the data cleansing system 10 obtains plant operation information or plant data from at least one of the plants 12a-12n, over the network 16. The desirable plant operation information or plant data includes plant operational parameters, plant process condition data, plant lab data, and/or information about plant constraints. As used herein, “plant lab data” refers to the results of periodic laboratory analyses of fluids taken from an operating process plant. As used herein, “plant process condition data” refers to data measured by sensors in the process plant.

In step 106, a plant process model is generated using the plant operation information. The plant process model estimates or predicts plant performance that is expected based upon the plant operation information (e.g., how at least one of plants 12a-12n is operated). The plant process model results may be used to monitor the health of at least one of plants 12a-12n and to determine whether any upset or poor measurement occurred. The plant process model is desirably generated by an iterative process that models at various plant constraints to determine the desired plant process model.

In step 108, a process simulation unit is used to model the operation of the at least one of plants 12a-12n. Because the simulation for the entire unit would be quite large and complex to solve in a reasonable amount of time, each of plants 12a-12n may be divided into smaller virtual sub-sections consisting of related unit operations. An illustrative process simulation unit 10, such as a UniSim® Design Suite, is disclosed in U.S. Patent Publication No. 2010/0262900, now U.S. Pat. No. 9,053,260, which is incorporated by reference in its entirety. Other illustrative related systems are disclosed in commonly assigned U.S. patent application Ser. Nos. 15/084,237 and 15/084,319 (Attorney Docket Nos. H0049260-01-8500 and H0049324-01-8500, both filed on Mar. 29, 2016), which are incorporated by reference in their entirety.

For example, in some embodiments, a fractionation column and its related equipment such as its condenser, receiver, reboiler, feed exchangers, and pumps may make up a sub-section. Some or all available plant data from the unit, including temperatures, pressures, flows, and/or laboratory data may be included in the simulation as Distributed Control System (DCS) variables. Multiple sets of the plant data may be compared against the process model and model fitting parameter and measurement offsets are calculated that generate the smallest errors.

In step 110, fit parameters or offsets that change by more than a predetermined threshold, and measurements that have more than a predetermined range of error, may trigger further action. For example, large changes in offsets or fit parameters may indicate the model tuning may be inadequate. Overall data quality for the set of data may then be flagged as questionable.

More specifically, a measured value and corresponding simulated value are evaluated for detecting an error based on a corresponding offset. In some embodiments, an offset may be detected when the measured information is not in sync with the simulated information. The system may use evidence from a number of measurements and/or a process model to determine the simulated information.

As an example only, consider the following measurements: a feed with the composition of 50% component A and 50% component B and a flow of 200 pounds per hour (90.7 kg/hr) and two product streams, the first with a composition 99% component A and a flow of 100 pounds per hour (45.3 kg/hr) and the second with a composition of 99% component B and 95 pounds per hour (43.1 kg/hr). Based on the first-principles model, the total feed may equal the total product and the total amount of A or B in the feed may equal the total amount of A or B in the product. The expected flow of the second product stream would be 100 pounds per hour (45.3 kg/hr), and the system may therefore determine that the offset between the measurement and simulation is 5 pounds per hour (2.27 kg/hr).

In step 112, when the offset is less than or equal to a predetermined value, control returns to step 104. Otherwise, control proceeds to step 114. Individual measurements with large errors may be eliminated from the fitting algorithm, and/or an alert message or warning signal may be raised to have the measurement inspected and rectified.

In step 114, the operational status of the measurements may be diagnosed based on at least one environmental factor. As discussed above, the calculated offset between the feed and product information may be evaluated based on the at least one environmental factor for detecting the fault of a specific measurement. If a measurement is determined to be within a fault status, an alert is sent to the operator (e.g., to an operator's device, a control panel, a dashboard). The method ends at step 116.

### SPECIFIC EMBODIMENTS

While the following is described in conjunction with specific embodiments, it will be understood that this description is intended to illustrate and not limit the scope of the preceding description and the appended claims.

A first embodiment of the disclosure is a system for improving operation of a plant, the cleansing system comprising a server coupled to the cleansing system for communicating with the plant via a communication network; a computer system having a web-based platform for receiving and sending plant data related to the operation of the plant over the network; a display device for interactively displaying the plant data; and a data cleansing unit configured for performing an enhanced data cleansing process for allowing an early detection and diagnosis of the operation of the plant based on at least one environmental factor, wherein the data cleansing unit calculates and evaluates an offset amount representing a difference between measured and simulated information for detecting an error of measurement during the operation of the plant based on the plant data. An embodiment of the disclosure is one, any or all of prior embodiments in this paragraph up through the first embodiment in this paragraph, wherein the at least one environmental factor includes at least one primary factor, and an optional secondary factor. An embodiment of the disclosure is one, any or all of prior embodiments in this paragraph up through the first embodiment in this paragraph, wherein the at least one primary factor includes at least one of a temperature, a pressure, a feed flow, and a product flow. An embodiment of the disclosure is one, any or all of prior embodiments in this paragraph up through the first embodiment in this paragraph, wherein the optional secondary factor includes at least one of a density value and a specific composition. An embodiment of the disclosure is one, any or all of prior embodiments in this paragraph up through the first embodiment in this paragraph, wherein the data cleansing unit is configured to receive at least one set of actual measured data from the plant on a recurring basis at a predetermined time interval. An embodiment of the disclosure is one, any or all of prior embodiments in this paragraph up through the first embodiment in this paragraph, wherein the data cleansing unit is configured to analyze the received data for completeness and correct an error in the received data for a measurement issue and an overall mass balance closure to generate a set of reconciled plant data. An embodiment of the disclosure is one, any or all of prior embodiments in this paragraph up through the first embodiment in this paragraph, wherein the data cleansing unit is configured such that the corrected data is used as an input to a simulation process, in which the process model is tuned to ensure that the simulation process matches the reconciled plant data. An embodiment of the disclosure is one, any or all of prior embodiments in this paragraph up through the first embodiment in this paragraph, wherein the data cleansing unit is configured such that an output of the reconciled plant data is inputted into a tuned flowsheet, and is generated as a predicted data. An embodiment of the disclosure is one, any or all of prior embodiments in this paragraph up through the first embodiment in this paragraph, wherein the data cleansing unit is configured such that a delta value representing a difference between the reconciled plant data and the predicted data is validated to ensure that a viable optimization case is established for a simulation process run. An embodiment of the disclosure is one, any or all of prior embodiments in this paragraph up through the first embodiment in this paragraph, wherein a tuned simulation engine is used as a basis for the viable optimization case being run with the reconciled plant data as an input, and an output from the turned simulation engine is an optimized data. An embodiment of the disclosure is one, any or all of prior embodiments in this paragraph up through the first embodiment in this paragraph, wherein a difference between the reconciled data and the optimized data indicates one or more plant variables that are capable of being changed to reach a greater performance for the plant. An embodiment of the disclosure is one, any or all of prior embodiments in this paragraph up through the first embodiment in this paragraph, further comprising a reconciliation unit configured for reconciling actual measured data from the plant in comparison with a performance process model result from a simulation engine based on a set of predetermined reference or set points. An embodiment of the disclosure is one, any or all of prior embodiments in this paragraph up through the first embodiment in this paragraph, wherein the reconciliation unit is configured to perform a heuristic analysis against the actual measured data and the performance process model result using a set of predetermined threshold values, and wherein the reconciliation unit is configured to receive the plant data from the plant via the computer system, and the received plant data represents the actual measured data from the equipment in the plant during a predetermined time period. An embodiment of the disclosure is one, any or all of prior embodiments in this paragraph up through the first embodiment in this paragraph, further comprising a diagnosis unit configured for diagnosing an operational status of the measurement by calculating the offset amount based on the at least one environmental factor. An embodiment of the disclosure is one, any or all of prior embodiments in this paragraph up through the first embodiment in this paragraph, wherein the diagnosis unit is configured to receive the feed and product information from the plant to evaluate the equipment, and to determine a target tolerance level of a final product based on at least one of an actual current operational parameter and a historical operational parameter for detecting the error of the equipment based on the target tolerance level.

A second embodiment of the disclosure is a method for improving operation of a plant, the cleansing method comprising providing a server coupled to a cleansing system for communicating with the plant via a communication network; providing a computer system having a web-based platform for receiving and sending plant data related to the operation of the plant over the network; providing a display device for interactively displaying the plant data, the display device being configured for graphically or textually receiving the plant data; obtaining the plant data from the plant over the network; performing an enhanced data cleansing process for allowing an early detection and diagnosis of the operation of the plant based on at least one environmental factor; and calculating and evaluating an offset amount representing a difference between feed and product information for detecting an error of equipment during the operation of the plant based on the plant data. An embodiment of the disclosure is one, any or all of prior embodiments in this paragraph up through the second embodiment in this paragraph, further comprising generating a plant process model using the plant data, estimating or predicting plant performance expected based on the plant data using the plant process model. An embodiment of the disclosure is one, any or all of prior embodiments in this paragraph up through the second embodiment in this paragraph, further comprising evaluating the measurement and simulation of the measurement for detecting the error of the measurement. An embodiment of the disclosure is one, any or all of prior embodiments in this paragraph up through the second embodiment in this paragraph, further comprising detecting the error of the measurement when the corresponding offset is less than or equal to a predetermined value. An embodiment of the disclosure is one, any or all of prior embodiments in this paragraph up through the second embodiment in this paragraph, further comprising diagnosing an operational status of the measurement by calculating the offset amount based on the at least one environmental factor.

Without further elaboration, it is believed that using the preceding description that one skilled in the art may use the present disclosure to its fullest extent and easily ascertain the essential characteristics of this disclosure, without departing from the spirit and scope thereof, to make various changes and modifications of the disclosure and to adapt it to various usages and conditions. The preceding specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A cleansing system for improving operation of a chemical plant, the cleansing system comprising:
a reactor;
a first flow sensor configured to measure a first product flow rate of a first product stream;
a second flow sensor configured to measure a second product flow rate of a second product stream;
a data cleansing platform comprising:
one or more first processors;
a first communication interface in communication with the first flow sensor and the second flow sensor; and
first non-transitory computer-readable memory storing executable instructions that, when executed by the one or more first processors, cause the data cleansing platform to:
receive the measured first product flow rate of the first product stream from the first flow sensor;
receive the measured second product flow rate of the second product stream from the second flow sensor;
calculate an offset amount representing a difference between the measured first product flow rate from the first flow sensor and a simulated first product flow rate of the first product stream determined from a simulation process model that simulates the chemical plant producing a first product;
evaluate the offset amount to determine an error of measurement during operation of the chemical plant to produce the first product; and
adjust, based on the offset amount, the simulation process model;
a user interaction platform comprising:
one or more second processors;
a second communication interface in communication with the data cleansing platform; and
second non-transitory computer-readable memory storing executable instructions that, when executed by the one or more second processors, cause the user interaction platform to:
receive diagnosis information comprising a recommended adjustment to an operational parameter of the chemical plant associated with the operation of the chemical plant to produce the first product; and
provide, for display via a user interface, the diagnosis information.

2. The cleansing system of claim 1, wherein the first non-transitory computer-readable memory stores further executable instructions that, when executed by the one or more first processors, cause the data cleansing platform to:
analyze the received first product flow rate for completeness; and
correct an error in the received first product flow rate for a measurement issue and an overall mass balance closure to generate a reconciled first product flow rate.

3. The cleansing system of claim 2, wherein the first non-transitory computer-readable memory stores further executable instructions that, when executed by the one or more first processors, cause the data cleansing platform to:
provide the reconciled first product flow rate as an input to the simulation process model; and
adjust the simulation process model to ensure that the simulated first product flow rate from the simulation process model matches the reconciled first product flow rate.

4. The cleansing system of claim 2, wherein the first non-transitory computer-readable memory stores further executable instructions that, when executed by the one or more first processors, cause the data cleansing platform to:
input the reconciled first product flow rate into a tuned flowsheet; and
using the tuned flowsheet, generate a predicted first product flow rate.

5. The cleansing system of claim 4, wherein the first non-transitory computer-readable memory stores further executable instructions that, when executed by the one or more first processors, cause the data cleansing platform to:
validate a delta value representing a difference between the reconciled first product flow rate and the predicted first product flow rate; and
establish, using the delta value, a viable optimization case for a run of the simulation process model.

6. The cleansing system of claim 5, wherein the first non-transitory computer-readable memory stores further executable instructions that, when executed by the one or more first processors, cause the data cleansing platform to:
based on the viable optimization case, run a tuned simulation engine with the reconciled first product flow rate as an input; and
receive an optimized first product flow rate as an output of the tuned simulation engine.

7. The cleansing system of claim 1, comprising:
a reconciliation platform comprising:
one or more third processors;
a third communication interface in communication with the data cleansing platform; and
third non-transitory computer-readable memory storing executable instructions that, when executed by the one or more third processors, cause the reconciliation platform to:
compare the measured first product flow rate from the first flow sensor against the simulated first product flow rate; and
reconcile the measured first product flow rate from the first flow sensor with the simulated first product flow rate based on a set of predetermined reference or set points.

8. The cleansing system of claim 7, wherein the third non-transitory computer-readable memory stores further executable instructions that, when executed by the one or more third processors, cause the reconciliation platform to:
perform a heuristic analysis against the measured first product flow rate from the first flow sensor and the simulated first product flow rate using a set of predetermined threshold values.

9. The cleansing system of claim 1, comprising:
a diagnosis platform comprising:
one or more third processors;
a third communication interface in communication with the data cleansing platform; and
third non-transitory computer-readable memory storing executable instructions that, when executed by the one or more third processors, cause the diagnosis platform to:
determine a target tolerance level of the first product based on at least one of the measured first product flow rate or a historical first product flow rate; and
use the target tolerance level of the first product to determine the recommended adjustment to the operational parameter of the chemical plant.

10. One or more non-transitory computer-readable media storing executable instructions that, when executed by at least one processor, cause a system comprising a reactor and a flow sensor configured to measure a product flow rate of a product stream to:
receive the measured product flow rate of the product stream from the flow sensor;
calculate an offset amount representing a difference between the measured product flow rate from the flow sensor and a simulated product flow rate of the product stream determined from a simulation process model that simulates a chemical plant producing a product;
evaluate the offset amount to determine an error of measurement during operation of the chemical plant to produce the product;
adjust, based on the offset amount, the simulation process model;
determine diagnosis information comprising a recommended adjustment to an operational parameter of the chemical plant associated with the operation of the chemical plant to produce the product; and
provide, for display via a user interface, the diagnosis information.

11. The one or more non-transitory computer-readable media of claim 10, storing further executable instructions that, when executed by the at least one processor, cause the system to:
analyze the received product flow rate for completeness; and
correct an error in the received product flow rate for a measurement issue and an overall mass balance closure to generate a reconciled product flow rate.

12. The one or more non-transitory computer-readable media of claim 11, storing further executable instructions that, when executed by the at least one processor, cause the system to:
provide the reconciled product flow rate as an input to the simulation process model; and
adjust the simulation process model to ensure that the simulated product flow rate from the simulation process model matches the reconciled product flow rate.

13. The one or more non-transitory computer-readable media of claim 11, storing further executable instructions that, when executed by the at least one processor, cause the system to:
input the reconciled product flow rate into a tuned flowsheet;
using the tuned flowsheet, generate a predicted product flow rate;
validate a delta value representing a difference between the reconciled product flow rate and the predicted product flow rate;
establish, using the delta value, a viable optimization case for a run of the simulation process model;
based on the viable optimization case, run a tuned simulation engine with the reconciled product flow rate as an input; and
receive an optimized product flow rate as an output of the tuned simulation engine.

14. The one or more non-transitory computer-readable media of claim 10, storing further executable instructions that, when executed by the at least one processor, cause the system to:
compare the measured product flow rate from the flow sensor against the simulated product flow rate;
reconcile the measured product flow rate from the flow sensor with the simulated product flow rate based on a set of predetermined reference or set points; and
perform a heuristic analysis against the measured product flow rate from the flow sensor and the simulated product flow rate using a set of predetermined threshold values.

15. The one or more non-transitory computer-readable media of claim 10, storing further executable instructions that, when executed by the at least one processor, cause the system to:
determine a target tolerance level of the product based on at least one of the measured product flow rate or a historical product flow rate; and
use the target tolerance level of the product to determine the recommended adjustment to the operational parameter of the chemical plant.

16. A method for improving operation of a chemical plant, the method comprising:
receiving, by a computing device, a measured product flow rate of a product stream from a flow sensor configured to measure a product flow rate of a product stream of a product produced by a chemical plant;
calculating, by the computing device, an offset amount representing a difference between the measured product flow rate from the flow sensor and a simulated product flow rate of the product stream determined from a simulation process model that simulates the chemical plant producing the product;
evaluating, by the computing device, the offset amount to determine an error of measurement during operation of the chemical plant to produce the product;
adjusting, by the computing device and based on the offset amount, the simulation process model;
determining, by the computing device, diagnosis information comprising a recommended adjustment to an operational parameter of the chemical plant associated with the operation of the chemical plant to produce the product; and
providing, by the computing device and for display via a user interface, the diagnosis information.

17. The method of claim 16, comprising:
analyzing the received product flow rate for completeness; and
correcting an error in the received product flow rate for a measurement issue and an overall mass balance closure to generate a reconciled product flow rate.

18. The method of claim 17, comprising:
providing the reconciled product flow rate as an input to the simulation process model; and
adjusting the simulation process model to ensure that the simulated product flow rate from the simulation process model matches the reconciled product flow rate.

19. The method of claim 17, comprising:
inputting the reconciled product flow rate into a tuned flowsheet;
using the tuned flowsheet, generating a predicted product flow rate;
validating a delta value representing a difference between the reconciled product flow rate and the predicted product flow rate;
establishing, using the delta value, a viable optimization case for a run of the simulation process model;
based on the viable optimization case, running a tuned simulation engine with the reconciled product flow rate as an input; and
receiving an optimized product flow rate as an output of the tuned simulation engine.

20. The method of claim 16, comprising:
determining, by the computing device, a target tolerance level of the product based on at least one of the measured product flow rate or a historical product flow rate; and
using, by the computing device, the target tolerance level of the product to determine the recommended adjustment to the operational parameter of the chemical plant.
